(19) United States
(12) Patent Application Publication
(10) Pub. No.: US 2023/0176225 A1
(43) Pub. Date: Jun. 8, 2023

(54) ROBOTIC WORKING TOOL SYSTEM AND METHOD

(71) Applicant: HUSQVARNA AB, Huskvarna (SE)

(72) Inventors: Anton Mårtensson, JÖNKÖPING (SE); Tommy Glimberg, Nässjö (SE); Sarkan Gazrawi, Huskvarna (SE); Jimmy Petersson, Jönköping (SE)

(21) Appl. No.: 17/911,548

(22) PCT Filed: Mar. 4, 2021
(86) PCT No.: PCT/SE2021/050190

§ 371 Date: Sep. 14, 2022

(30) Foreign Application Priority Data
Mar. 18, 2020 (SE) 2050294-4

(51) Int. Cl. G01S 19/04; G05D 1/02; G01S 19/43; A01D 34/00

(52) U.S. Cl. CPC G01S 19/04; G05D 1/0278; G01S 19/43; A01D 34/008; G05D 2201/0208; A01D 2101/00

(57) ABSTRACT

The present disclosure relates to a robotic working tool system comprising a robotic working tool (1), and navigation means enabling the robotic working tool to navigate within a working area (3) defined by a working area boundary (13). The navigation means comprising a base RTK unit (9), adapted to be stationary during operation of the robotic working tool (1), a mobile RTK unit (11), adapted to move with and provide positioning data to the robotic working tool (1), and a recording RTK unit (11, 9, 17) which is separate from or separable from the robotic working tool (1) to be moved along a path (15) to record position data corresponding to the working area boundary (13) independently of the robotic working tool (1), and to transfer the position data to the robotic working tool (1).

### TECHNICAL FIELD

The present disclosure relates to a robotic working tool system comprising a robotic working tool, and navigation arrangement enabling the robotic working tool to navigate within a working area defined by a working area boundary.

### BACKGROUND

Such robotic work tools systems, for instance comprising robotic lawn mowers, are widely used. Typically, the working area boundary is marked by burying a boundary wire in the ground and feeding a signal to the wire that can be detected by the robotic lawnmower, thereby enabling it to detect the boundary and remain in the working area.

One general problem associated with such robotic work tools is that they are cumbersome and difficult to install, specifically the burying of the cable.

### SUMMARY

One object of the present disclosure is therefore to provide a robotic work tool system that can be more easily installed.

This object is achieved by means of a robotic work tool system as defined in claim 1. More specifically, in a system of the initially mentioned kind, the navigation arrangement comprises a base real time kinematic, RTK, unit, which is adapted to be stationary during operation of the robotic working tool, and a mobile RTK unit, adapted to move with and provide positioning data to the robotic working tool that can be used for navigating. An auxiliary RTK unit is also provided which is configured to be separate from the robotic working tool. The auxiliary mobile RTK unit may comprise a mobile phone. Thereby, the auxiliary RTK unit is able to be moved along a path to record position data corresponding to the working area boundary independently of the robotic working tool, and to subsequently transfer the position data to the robotic working tool.

This allows a user to very quickly record a boundary, simply by walking the boundary carrying the auxiliary RTK unit, and subsequently transfer this information to the mobile RTK unit of the robotic working tool. This provides a very simple and reliable way of establishing a robotic work tool system.

The present disclosure also considers a corresponding method comprising moving an auxiliary RTK unit, separately from the robotic working tool, along a path to record position data corresponding to the working area boundary, transferring the position data from the auxiliary RTK unit to the robotic working tool, and navigating the robotic working tool using the position data.

### BRIEF DESCRIPTION OF THE DRAWINGS

FIG. 1 illustrates schematically a self-propelled robotic tool system according to known art.

FIG. 2 illustrates schematically a self-propelled robotic tool system according to a first example of the present disclosure.

FIG. 3 illustrates schematically a self-propelled robotic tool system according to a second example of the present disclosure.

FIG. 4 illustrates schematically a self-propelled robotic tool system according to a third example of the present disclosure.

FIG. 5 illustrates a flow-chart for a basic method of operating a robotic work tool system.

### DETAILED DESCRIPTION

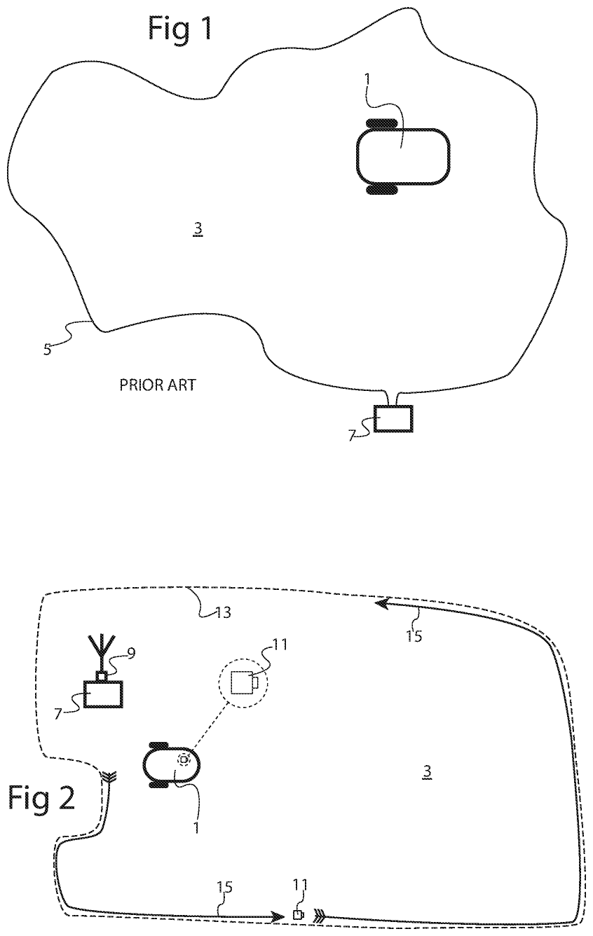

The present disclosure relates generally to self-propelled robotic work tools. FIG. 1 illustrates schematically a self-propelled robotic tool 1 operating according to known art. Typically, such a robotic tool 1 operates within a work area 3 which is defined by a buried boundary cable 5. This cable 5 may be connected to e.g. a charging station 7, also capable to intermittently charge the robotic tool 1. A signal is applied to the cable 5, allowing the robotic tool to sense that it is about to cross the cable 5 and exit the working area 3. Thereby, the robotic tool 1 can change its heading accordingly and remain within the working area 3, which is important for efficiency and safety reasons.

As it however is cumbersome to install this system, specifically burying the cable in the ground, it has been suggested to use other means than a boundary cable 5 to keep the robotic tool 1 within the working area 3. One such option is satellite navigation, specifically enhanced with real time kinematics, as will be discussed below, as satellite navigation as such in many cases provide positioning with too low precision for many robotic work tool applications.

By real-time kinematic positioning, hereinafter RTK, is generally meant an enhanced satellite navigation technique using positioning data from satellite-based positioning systems such as GPS, GLONASS, Galileo, etc. In some cases, the term carrier-phase enhancement is also used.

RTK, in addition to information content of a received satellite signal, uses the phase of the received signal's carrier wave to produce correction data capable of enhancing position determining with up to centimeter-level accuracy.

RTK systems use a base-station unit and one or more mobile units, each unit having a satellite navigation receiver. The base station, which is stationary, observes the phase of the received satellite signal carrier and transmits correction data corresponding to the observed phase to the mobile units. Each mobile unit may then use its own phase measurement with the correction data received from the base station. Based on this comparison a very precise position determination can be established, which is accurate enough to navigate a self-propelled robotic tool such as a robotic lawnmower. Therefore, a self-propelled robotic tool with RTK capability could optionally dispense with the boundary wire.

The question then arises as to how information regarding the working area 3 should be provided to the robotic work tool 1. One conceivable option to achieve this is to make the robotic work tool 1 travel along the boundary of the working area 3 to record the corresponding positions. In the example with a robotic lawn mower, a user may then steer the lawnmower along the boundary of the lawn to be cut, this feeds the corresponding data into the lawnmower when detecting its position along the boundary, and a simple algorithm can then be used not only to keep the lawnmower on the lawn, but also to ensure that the surface of the lawn becomes evenly cut.

By recording positions may be meant that positions are registered at regular intervals or more or less continuously. It is also possible to let user interaction trigger registering of a position.

However, that scheme has some drawbacks. To start with, a robotic lawn mower moves relatively slowly. Therefore, driving the lawn mower along the lawn boundary is a time-consuming, and frankly quite boring, task. Secondly, the end user will need to learn how to steer the lawn mower, using an input device such as a joystick or the like. Thirdly, such input means will need be provided, although they will much likely be used only once.

The present disclosure therefore introduces a robotic working tool system, and a method for operating such a system, that is improved to wholly or partly avoid the above drawbacks. This is done by providing a unit that is separate from, or separable from, the robotic working tool and that is used to record the working area boundary position data. Then, that data is applied in the robotic working tool which becomes capable to operate accordingly, processing the working area, and remaining therein, possibly with some exceptions according to predetermined rules.

FIG. 2 illustrates schematically a self-propelled robotic tool system according to a first example of the present disclosure. There is provided a base RTK unit 9, which in the illustrated case is integrated with the robotic working tool's charging station 7. This however is not necessary. It is possible to mount the base RTK unit 9 for instance on a building nearby, although it is preferred that the base RTK unit 9 is fixed, as it provides a reference point for the robotic working tool's 1 navigation. The charging station 7 may however conveniently provide supply power for the base RTK unit 9. Note that the charging station 7 need not be located at the boundary of the working area 3 as there is no boundary wire to connect with.

There is provided a mobile RTK unit 11 in the robotic working tool 1, which can receive signals from satellites as well as correction data from the base RTK unit 9 in order to determine the robotic working tool's 1 position accurately. In this case, the mobile RTK unit 11 associated with the robotic working tool 1 is separable therefrom.

In a case where a user wishes to establish a virtual boundary 13 that defines the working area 3, the user could therefore detach the mobile RTK unit 11 from the robotic work tool 1 and walk with the mobile RTK unit 11 along a path 15 corresponding to the virtual boundary 13. The mobile RTK unit 11 thereby records and stores the corresponding positions, and this can be achieved much faster and more conveniently than if the robotic tool 1 would have to be moved along the path 15. When re-attached to the self-propelled robotic tool 1, those stored positions in the mobile RTK unit 11 can therefore be used to navigate the robotic tool 1.

FIG. 3 illustrates schematically a self-propelled robotic tool system according to a second example of the present disclosure. In this case, the base RTK station 9 is used to record the positions corresponding to the virtual boundary 13 of the working area 3 by being moved along the path 15. This is possible as in an RTK system a base unit and a mobile unit can have more or less identical capabilities, i.e. to receive satellite signals, detect carrier signal phase, and communicate with each other. In this case, a mobile RTK unit 11 in the robotic work tool 1 functions as the base unit, typically connected to the charging station 7. Once the positions of the path 15 have been recorded the base RTK station 9 is made stationary, typically at the charger station 7, and the position data is transferred to the robotic work tool 1, which may the navigate accordingly. If the base RTK station 9 is instead mounted at another location such as a building or the like, an offset is added to the position data, corresponding to the position of the base RTK station location in relation to the charging station 7 or other location where the robotic tool was located when the path 15 position data was recorded. Most likely some offset should be applied in most cases as the base RTK stations 9 position during operation of the robotic tool will probably not be identical to the mobile RTK station's 11 location during recording of the virtual boundary 13.

This example also allows position data corresponding to the virtual boundary 13 of the working area 3 to be recorded without moving the robotic work tool 1.

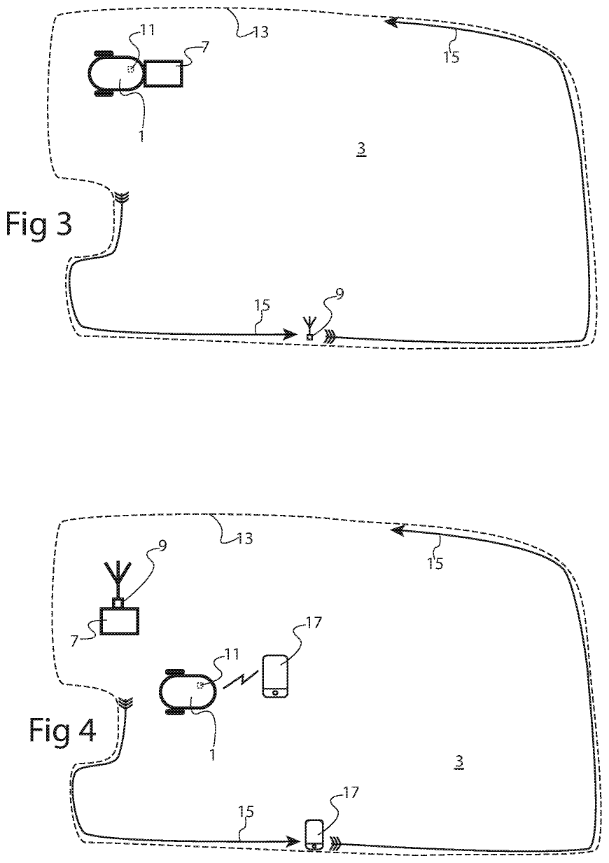

FIG. 4 illustrates schematically a self-propelled robotic tool system according to the third and preferred example of the present disclosure. In this case a separate mobile RTK unit 17 is used to record the position data of the path 15. This may be a dedicated RTK unit, but it is possible also to use e.g. a mobile phone with RTK peripherals or integrated RTK capabilities to this end. The user can then run an application on the separate RTK unit 17, which application is dedicated for RTK positioning.

Just like the detachable mobile RTK unit 11 of FIG. 2 the separate RTK unit 17 is moved along the path 15 corresponding to the virtual boundary 13 of the working area 3 in order to record the corresponding positions in communication with the base RTK unit 9. Once this procedure is completed, the position data is transferred to the robotic working tool 1, which is thereby made capable of navigating within the working area 3.

As another alternative, it is possible to let the separate RTK unit 17 record the virtual boundary while receiving correction data from another base RTK unit (not shown), which may provide a universal RTK service, for instance. If so, the separate RTK unit 17 records the virtual boundary 13 in a global coordinate system and not in relation to the base RTK unit 9 intended to be used during operation of the robotic work tool. However, it is possible to let the base RTK unit 9 and the robotic work tool operate in a global coordinate system as well, so this is a conceivable alternative.

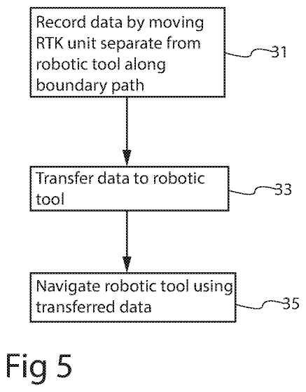

FIG. 5 illustrates a flow-chart for a basic method of operating a robotic work tool system. The method involves moving 31 the recording RTK unit 11, 9, 17, separately from the robotic working tool 1, along a path 15 to record position data corresponding to the working area boundary 13. Further, the method includes transferring 33 the position data from the recording RTK unit to the robotic working tool 1 and navigating 35 the robotic working tool 1 using that position data.

The present disclosure is not limited to the above-described examples and may be varied and altered in different ways within the scope of the appended claims.

1. A robotic working tool system comprising a robotic working tool, and a navigation arrangement enabling the robotic working tool to navigate within a working area defined by a working area boundary, wherein said navigation arrangement comprises a base RTK unit, adapted to be stationary during operation of the robotic working tool, a mobile RTK unit, adapted to move with and provide positioning data to the robotic working tool during operation, and an auxiliary RTK unit which is configured to be separate from the robotic working tool and to be moved along a path to record position data corresponding to the working area boundary independently of the robotic working tool, and to subsequently transfer said position data to the robotic working tool, wherein the auxiliary RTK unit comprises the base RTK unit, configured to be moved along said path while the mobile RTK unit is adapted to be stationary.

2. A method for operating a working tool system, the system comprising a robotic working tool, and navigation means enabling the robotic working tool to navigate within a working area defined by a working area boundary, said navigation means comprising a base RTK unit, adapted to be stationary during operation of the robotic working tool, and a mobile RTK unit, adapted to move with and provide positioning data to the robotic working tool, the method comprising
moving an auxiliary RTK unit, in the form of the base RTK unit, along a path to record position data corresponding to the working area boundary, while the mobile RTK unit is stationary,
transferring said position data from the auxiliary RTK unit to the robotic working tool, and
navigating the robotic working tool using said position data.

3. The robotic working tool system according to claim 1, wherein the base RTK unit is configured to be integrated with the charger station during operation of the robotic working tool.

4. The robotic working tool system according to claim 3, wherein the base RTK unit is configured to be supplied with power from the charger station.

5. The robotic working tool system according to claim 1, wherein the base RTK unit is configured be mounted at another location than the charger station during operation of the robotic working tool, and wherein an offset is added to the transferred position data.

6. The method according to claim 2, wherein the base RTK unit is integrated with the charger station during operation of the robotic working tool.

7. The method according to claim 6, wherein the base RTK unit is supplied with power from the charger station.

8. The method according to claim 2, wherein the base RTK unit is mounted at another location than the charger station during operation of the robotic working tool, and wherein an offset is added to the transferred position data.
